(19) United States
(12) Patent Application Publication
(10) Pub. No.: US 2015/0375373 A1
(43) Pub. Date: Dec. 31, 2015

(54) Wrench

(71) Applicant: PRIMAPLUS INDUSTRIAL CO., LTD., Taichung City (TW)

(72) Inventor: Jason Chang, Taichung City (TW)

(21) Appl. No.: 14/314,082

(22) Filed: Jun. 25, 2014

(51) Int. Cl. B25B 13/06

(52) U.S. Cl. CPC B25B 13/065

(57) ABSTRACT

A wrench includes a wrench body provided with a hollow mounting hole which is mounted on a workpiece which has a plurality of outer sides and a plurality of corners. The mounting hole of the wrench body is provided with a plurality of locking edges and a plurality of receiving grooves. Thus, the receiving grooves of the wrench body receive the corners of the workpiece to prevent the wrench body from contacting the corners of the workpiece, so that the corners of the workpiece will not be rubbed when the wrench body drives the workpiece. In addition, the locking edges of the wrench body press and provide a force to drive the outer sides of the workpiece so that the wrench body can be used to drive the workpiece whose corners have been worn out, without producing slip during operation.

### BACKGROUND OF THE INVENTION

1. Field of the Invention

The present invention relates to a hand tool and, more particularly, to a combination wrench for driving a workpiece, such as a screw, nut and the like.

2. Description of the Related Art

A conventional wrench in accordance with the prior art shown in FIGS. 9-11 comprises a wrench body 1 provided with a mounting hole 11. The mounting hole 11 of the wrench body 1 is mounted on a screw 2 and has an inner periphery provided with a plurality of driving portions 12 fitted onto the corners 21 of the screw 2. In operation, the driving portions 12 of the wrench body 1 lock the corners 21 of the screw 2, so that when the wrench body 1 is rotated, the driving portions 12 of the wrench body 1 drive and rotate the corners 21 of the screw 2 to rotate the screw 2 so as to tighten or loosen the screw 2. However, the driving portions 12 of the wrench body 1 directly contact the corners 21 of the screw 2 as shown in FIG. 10 so that the corners 21 of the screw 2 are subjected to a larger force and are easily worn out during a long-term utilization, thereby decreasing the lifetime of the screw 2. In addition, when the corners 21 of the screw 2 are worn out as shown in FIG. 11, the driving portions 12 of the wrench body 1 easily slip from the corners 21 of the screw 2, so that the wrench body 1 cannot operate the screw 2 any more, thereby failing the screw 2.

### BRIEF SUMMARY OF THE INVENTION

In accordance with the present invention, there is provided a wrench comprising a wrench body provided with a hollow mounting hole. The mounting hole of the wrench body is mounted on a workpiece which has a plurality of outer sides and a plurality of corners. The mounting hole of the wrench body has an entrance end and an opening end. The mounting hole of the wrench body is provided with a plurality of locking edges each corresponding to the respective outer side of the workpiece and a plurality of receiving grooves each corresponding to the respective corner of the workpiece. Each of the receiving grooves of the wrench body is located between and connected with two of the locking edges. Each of the locking edges of the wrench body extends in the opening end toward a respective one of a plurality of first imaginary lines, with an inclined section being defined between each of the locking edges of the wrench body and the respective first imaginary line. Each of the first imaginary lines is parallel with the respective outer side of the workpiece. Each of the locking edges and each of the receiving grooves of the wrench body has an connection which is formed with a respective one of a plurality of second imaginary lines, with a rotation space being defined between each of the second imaginary lines and each of the first imaginary lines.

According to the primary advantage of the present invention, the receiving grooves of the wrench body receive the corners of the workpiece to prevent the wrench body from directly contacting the corners of the workpiece, so that the corners of the workpiece will not be rubbed or worn when the wrench body drives the workpiece, thereby enhancing the lifetime of the workpiece.

According to another advantage of the present invention, the locking edges of the wrench body press and provide a force to drive the outer sides of the workpiece so that the wrench body can be used to drive the workpiece whose corners have been worn out, without producing slip during operation.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a wrench in accordance with the preferred embodiment of the present invention.

FIG. 2 is a front view of the wrench as shown in FIG. 1.

FIG. 3 is a locally enlarged cross-sectional view of the wrench as shown in FIG. 2.

FIG. 4 is an operational view of the wrench as shown in FIG. 3 in use.

FIG. 5 is a top cross-sectional operational view of the wrench as shown in FIG. 1.

FIG. 6 is another operational view of the wrench as shown in FIG. 3 in use.

FIG. 7 is another operational view of the wrench as shown in FIG. 3 in use.

FIG. 8 is another operational view of the wrench as shown in FIG. 5.

FIG. 9 is a front view of a conventional wrench in accordance with the prior art.

FIG. 10 is a locally enlarged cross-sectional operational view of the conventional wrench for a screw as shown in FIG. 9.

FIG. 11 is a locally enlarged cross-sectional operational view of the conventional wrench for a screw having worn corners as shown in FIG. 9.

### DETAILED DESCRIPTION OF THE INVENTION

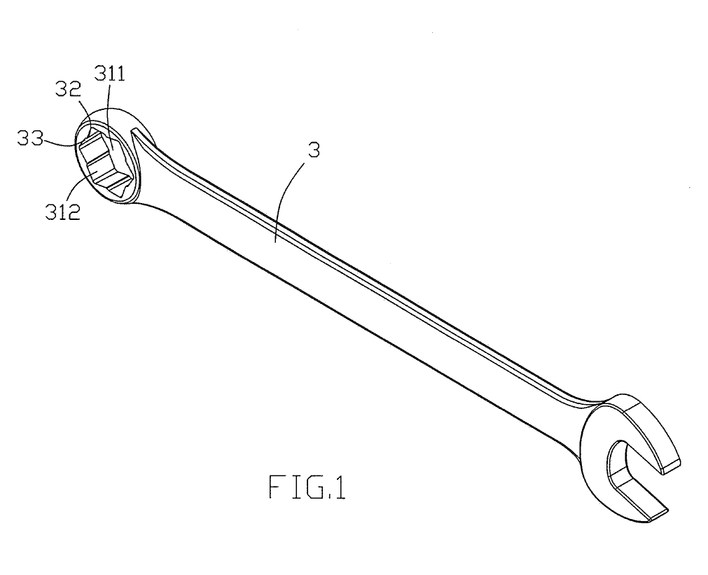

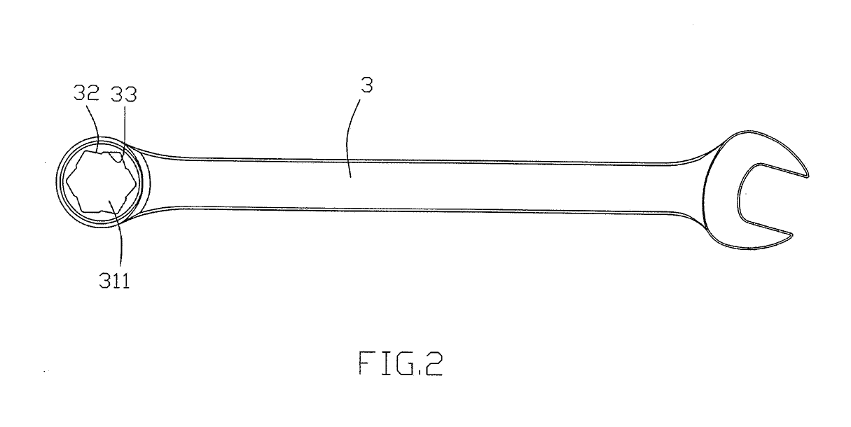

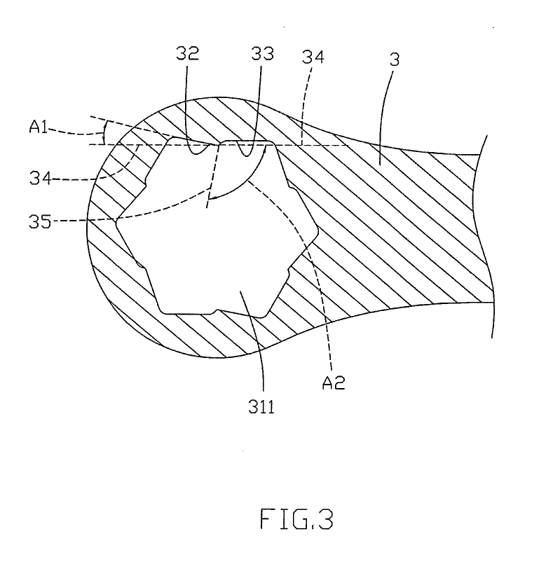

Referring to the drawings and initially to FIGS. 1-5, a wrench in accordance with the preferred embodiment of the present invention comprises a wrench body 3 provided with a hollow mounting hole 31. The mounting hole 31 of the wrench body 3 is mounted on a screw 4 which has a plurality of outer sides 42 and a plurality of corners 41.

The mounting hole 31 of the wrench body 3 has an entrance end 311 and an opening end 312. The mounting hole 31 of the wrench body 3 is provided with a plurality of locking edges 32 each corresponding to the respective outer side 42 of the screw 4 and a plurality of receiving grooves 33 each corresponding to the respective corner 41 of the screw 4. Each of the receiving grooves 33 of the wrench body 3 is located between and connected with two of the locking edges 32.

The locking edges 32 and the receiving grooves 33 of the wrench body 3 are arranged in a staggered manner and are extended from the entrance end 311 to the opening end 312 of the mounting hole 31. The locking edges 32 and the receiving grooves 33 of the wrench body 3 are connected to form the mounting hole 31 which has a polygonal endless shape.

Each of the locking edges 32 of the wrench body 3 extends in the opening end 312 toward a respective one of a plurality of first imaginary lines 34, with an inclined section “A1” being defined between each of the locking edges 32 of the wrench body 3 and the respective first imaginary line 34. Preferably, the inclined section “A1” has an angle ranged between one degree and ten degrees)(1°-10°). In the preferred embodiment of the present invention, the inclined section “A1” has an optimum angle of seven degrees)(7°). Each of the first imaginary lines 34 is parallel with the respective outer side 42 of the screw 4.

Each of the locking edges 32 and each of the receiving grooves 33 of the wrench body 3 has an connection which is formed with a respective one of a plurality of second imaginary lines 35, with a rotation space “A2” being defined between each of the second imaginary lines 35 and each of the first imaginary lines 34. Preferably, the rotation space “A2” has an angle ranged between ninety degrees and one hundred and seventy degrees)(90°-170°). In the preferred embodiment of the present invention, the rotation space “A2” has an optimum angle of one hundred and one degrees)(101°).

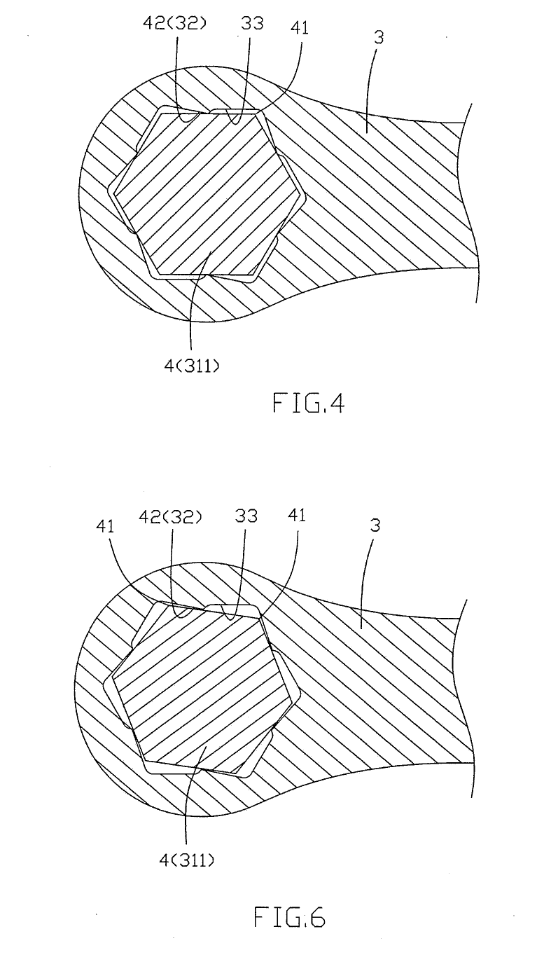

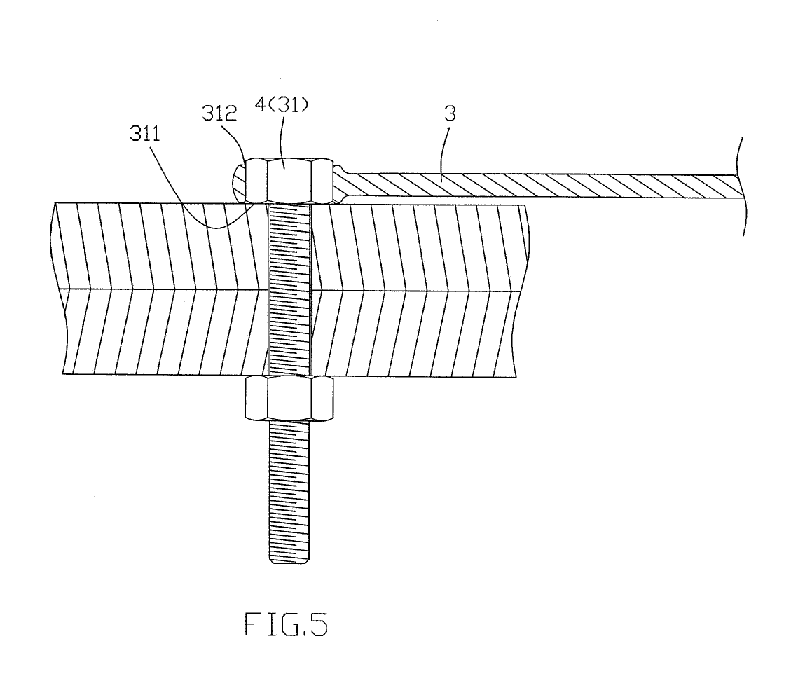

In operation, referring to FIGS. 4 and 5 with reference to FIGS. 1-3, when the mounting hole 31 of the wrench body 3 is mounted on the screw 4, the screw 4 initially passes through the entrance end 311 into the mounting hole 31 of the wrench body 3, so that each of the locking edges 32 of the wrench body 3 presses and locks the respective outer side 42 of the screw 4, and each of the receiving grooves 33 of the wrench body 3 receives the respective corner 41 of the screw 4. In such a manner, when the wrench body 3 is rotated in the clockwise or counterclockwise direction to drive the screw 4, the locking edges 32 of the wrench body 3 respectively drive and rotate the outer sides 42 of the screw 4, to drive and rotate the screw 4, so as to tighten or loosen the screw 4. At this time, the receiving grooves 33 of the wrench body 3 respectively receive the corners 41 of the screw 4 as shown in FIG. 4, to reduce the force applied on the corners 41 of the screw 4, and to reduce the wear loss the corners 41 of the screw 4, thereby enhancing the lifetime of the screw 4.

On the other hand, referring to FIG. 6 with reference to FIGS. 1-5, the screw 4 has a size slightly smaller than that of the mounting hole 31 of the wrench body 3. At this time, each of the locking edges 32 of the wrench body 3 is located at different positions of the respective outer side 42 of the screw 4 by provision of the inclined section “A1” defined between each of the locking edges 32 of the wrench body 3 and the respective first imaginary line 34, so that each of the locking edges 32 of the wrench body 3 will not interfere with the respective corner 41 of the screw 4. In addition, when each of the locking edges 32 of the wrench body 3 abuts the respective outer side 42 of the screw 4, there is an enough rotation space in the mounting hole 31 of the wrench body 3 by accommodation of the rotation space “A2”, so that the outer sides 42 and the corners 41 of the screw 4 will not interfere with the receiving grooves 33 of the wrench body 3. Thus, the wrench body 3 can tighten or loosen the screw 4 easily and conveniently.

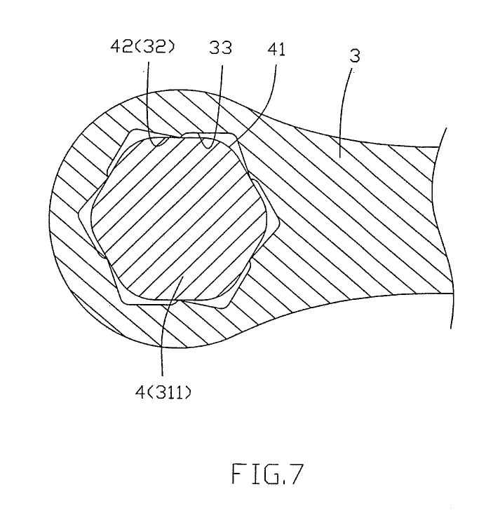

Referring to FIG. 7, the corners 41 of the screw 4 are worn out. When the mounting hole 31 of the wrench body 3 is mounted on the screw 4, the locking edges 32 of the wrench body 3 still press the outer sides 42 of the screw 4, to drive and rotate the outer sides 42 of the screw 4, so as to tighten or loosen the screw 4.

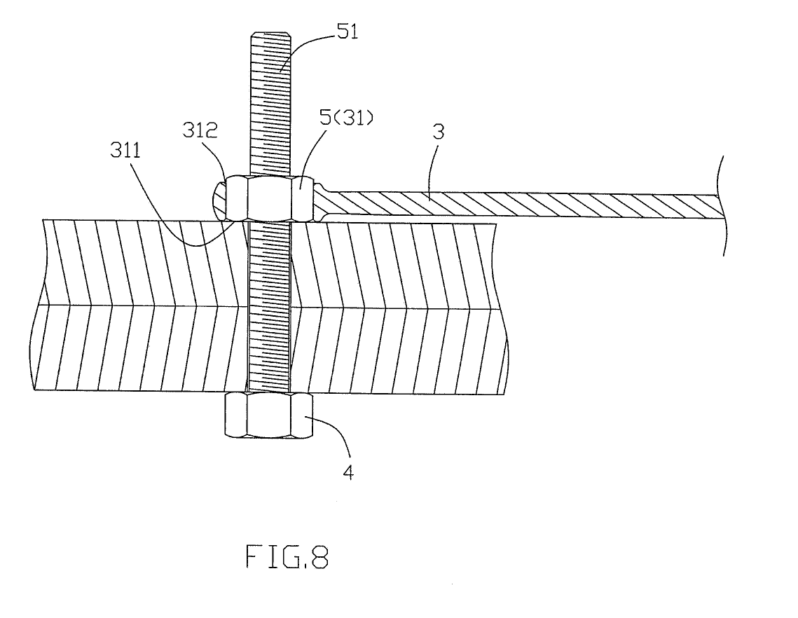

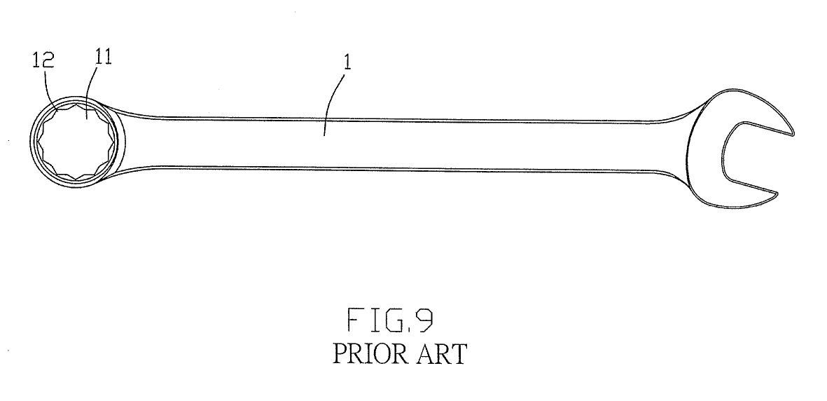

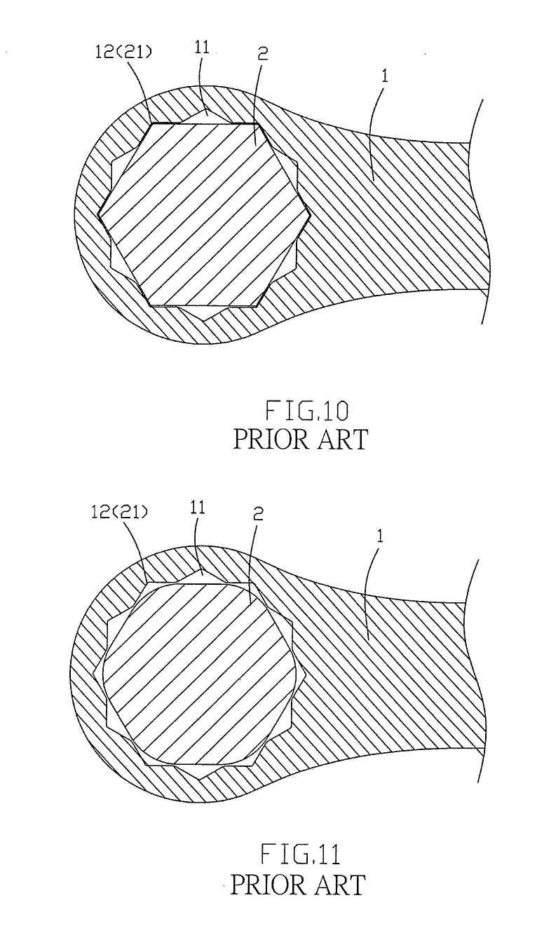

Referring to FIG. 8 with reference to FIGS. 1-5, the mounting hole 31 of the wrench body 3 is mounted on a nut 5 whose corners have been worn out. The nut 5 is mounted on a threaded rod 51. When the mounting hole 31 of the wrench body 3 is mounted on the nut 5, the threaded rod 51 extends from the entrance end 311 to the opening end 312 of the mounting hole 31 and extends through the mounting hole 31 of the wrench body 3, so that the locking edges 32 of the wrench body 3 can respectively press and lock the outer sides of the nut 5 to drive and rotate the nut 5 so as to tighten or loosen the nut 5.

In the preferred embodiment of the present invention, the entrance end 311 of the mounting hole 31 has a diameter equal to that of the opening end 312 of the mounting hole 31.

In another preferred embodiment of the present invention, the entrance end 311 of the mounting hole 31 has a diameter greater than that of the opening end 312 of the mounting hole 31, so that the mounting hole 31 of the wrench body 3 has a tapered shape and gradually reduces from the entrance end 311 to the opening end 312. Preferably, the mounting hole 31 of the wrench body 3 has a tapered angle ranged between one degree and 5 degrees) (1°-5°).

Accordingly, the receiving grooves 33 of the wrench body 3 receive the corners of a workpiece, such as a screw, nut and the like to prevent the wrench body 3 from directly contacting the corners of the workpiece, so that the corners of the workpiece will not be rubbed or worn when the wrench body 3 drives the workpiece, thereby enhancing the lifetime of the workpiece. In addition, the locking edges 32 of the wrench body 3 press and provide a force to drive the outer sides of the workpiece so that the wrench body 3 can be used to drive the workpiece whose corners have been worn out, without producing slip during operation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wrench comprising:
a wrench body provided with a hollow mounting hole;
wherein:
the mounting hole of the wrench body is mounted on a workpiece which has a plurality of outer sides and a plurality of corners;
the mounting hole of the wrench body has an entrance end and an opening end;
the mounting hole of the wrench body is provided with a plurality of locking edges each corresponding to the respective outer side of the workpiece and a plurality of receiving grooves each corresponding to the respective corner of the workpiece;
each of the receiving grooves of the wrench body is located between and connected with two of the locking edges;
each of the locking edges of the wrench body extends in the opening end toward a respective one of a plurality of first imaginary lines, with an inclined section being defined between each of the locking edges of the wrench body and the respective first imaginary line;
each of the first imaginary lines is parallel with the respective outer side of the workpiece; and
each of the locking edges and each of the receiving grooves of the wrench body has an connection which is formed with a respective one of a plurality of second imaginary lines, with a rotation space being defined between each of the second imaginary lines and each of the first imaginary lines.

2. The wrench of claim 1, wherein the inclined section has an angle ranged between one degree and ten degrees)(1°-10°).

3. The wrench of claim 1, wherein the rotation space has an angle ranged between ninety degrees and one hundred and seventy degrees) (90°-170°).

4. The wrench of claim 1, wherein the locking edges and the receiving grooves of the wrench body are extended from the entrance end to the opening end of the mounting hole.

5. The wrench of claim 1, wherein the entrance end of the mounting hole has a diameter equal to that of the opening end of the mounting hole.

6. The wrench of claim 1, wherein the entrance end of the mounting hole has a diameter greater than that of the opening end of the mounting hole, and the mounting hole of the wrench body has a tapered shape and gradually reduces from the entrance end to the opening end.

7. The wrench of claim 2, wherein the inclined section has an optimum angle of seven degrees)(7°).

8. The wrench of claim 3, wherein the rotation space has an optimum angle of one hundred and one degrees)(101°).
